(19) United States
(12) Patent Application Publication
(10) Pub. No.: US 2025/0136880 A1
(43) Pub. Date: May 1, 2025

(54) METHOD AND SYSTEM FOR PRODUCING SYNGAS FROM A COMBUSTIBLE MATERIAL

(71) Applicant: WILDFIRE TECHNOLOGIES PTY LTD, Brisbane (AU)

(72) Inventors: Gregory Martin Parry PERKINS, Brisbane (AU); Denis Alexander DOUCET, Brisbane (AU)

(21) Appl. No.: 18/836,791

(22) PCT Filed: Feb. 9, 2023
(86) PCT No.: PCT/AU2023/050083

§ 371 Date: Aug. 8, 2024

(30) Foreign Application Priority Data
Feb. 9, 2022 (AU) 2022900268

(51) Int. Cl. C10J 3/72; F23G 5/04; F23G 5/44

(52) U.S. Cl. CPC C10J 3/723; C10J 3/726; C10J 3/728; F23G 5/04; F23G 5/444; C10J 2200/09; C10J 2200/152; C10J 2200/154; C10J 2300/0946; F23G 2201/10; F23G 2202/20; F23G 2203/803

(57) ABSTRACT

A method of producing a gas from a combustible material is provided. The method comprises the steps of loading the combustible material into a containment structure and sealing it therein. An oxidant is fed into the sealed containment structure with a controlled flow rate and a controlled rate of movement such that the combustible material is partly converted, thereby leaving behind thermally affected layers of combustible material after the injection point has passed through the material. At least some of the combustible material is converted into molten slag and or char that accumulates as the bottom-most thermally affected layer and subsequently cools and solidifies. The method is characterised in that it further includes the step of discharging solid slag and or char in the bottom-most thermally affected layer from under material that remains in the containment structure to remove solid slag and or char from the containment structure.

This document claims priority to AU 2022900268 filed on 9 Feb. 2022 the contents of which are hereby incorporated by reference in their entirety.

### TECHNICAL FIELD

This invention relates to a method for producing gas from a combustible material such as biomass and solid waste. In particular, a device and method for batch gasification of a combustible material is disclosed.

### BACKGROUND

Gasification is a process by which gas is produced from a carbonaceous feedstock by partial oxidation. The product gas is typically referred to as ‘synthesis gas’ or ‘syngas’ and can be used as a feedstock for various applications including electricity generation, hydrogen production, synthetic fuel production and chemicals production. It is well known that gasification occurs in reducing atmospheres at high temperatures, typically in the range from about 700 to 1500 degrees Centigrade.

Major challenges of biomass and waste gasification include high capital and operating costs, operational difficulties caused by variable feedstock properties and high tar levels in the syngas. Due to the small quantities and dispersed nature of biomass and waste sources most biomass and waste gasifiers have small capacities (in the range of 1s to 10s of MWt) compared to coal or petroleum coke gasifiers (in the range of 100s to 1000s of MWt) resulting in poor economy of scale. Biomass and waste can be highly variable in moisture content, energy content, density, size and shape especially when obtained from waste sources. The variable properties of biomass and waste can result in poor gasifier performance and poor availability.

Almost all solid combustible materials contain components which are inert in a combustion process and these components are called inorganic matter and are more commonly referred to as ash—as these components form ash when the material is combusted in a conventional fire. Solid ash forms at temperatures below the ash fusion temperature. At much higher temperatures the ash can melt, forming a slag which can be molten (if kept sufficiently hot) or more generally is cooled and solidified into an inert rock.

Gasifiers are commercially available and come in a wide range of types including updraft, downdraft, crossdraft, fluidised bed, entrained flow and plasma. Peak temperatures range from about 700 degrees Centigrade to well over 1500 degrees Centigrade depending upon the design. Each of the different types of gasifiers have different characteristics in terms of cost, capacity, efficiency, gas quality, load following capability and feedstock suitability. Notably, almost all existing gasifier designs utilise a large vertical reactor vessel and require a steady feed of processed feedstock into the gasifier to maintain constant gas production and require continuous removal of the inerts in the feedstock in the form of solid ash or molten slag.

Updraft gasifiers processing biomass generally remove the waste ash continuously as a dry solid using a rotary grate and a screw or auger. An example can be found in European Patent Application 2 589 870 A1. A disadvantage of this technique is that the ash must be prevented from melting and forming an agglomerate or slag, which would block the grate and auger. Slagging is a common problem in gasification particularly for feedstocks which produce ash with a low fusion temperature. Slag formation can cause blockages and damage ash removal systems This can be achieved by only processing feedstocks with relatively high ash fusion temperatures and also by ensuring that the peak temperature of the reaction zone is kept quite low by using a moderator in the oxidant. Unfortunately, these requirements rule out the use of most solid waste feedstocks, such as municipal solid waste (MSW).

High temperature gasifiers for processing residual wastes such as municipal solid waste exist and have peak temperatures between about 1200 and 1600 degrees Centigrade. However, these gasifiers generally contain a separate hearth or vitrification reactor in which the ash is heated above its melting temperature to form a molten bath of slag in a separate zone or reactor and is removed as a molten liquid at very high temperature. To keep the slag molten, temperatures above 1500 degrees Centigrade are required. U.S. Pat. No. 9,074,152 B2 (to Nielsen et al.) describes a gasifier with slag melting in a bottom zone of the reactor and plasma torches in a top zone to maintain syngas temperatures of 1200 to 1500 degrees Centigrade. The disadvantage of this design is that very expensive and thick refractory and insulation layers are required to contain the molten slag and additional energy in the form of combustion or plasma generation or electrical heating is required to maintain the temperature and keep the slag in its molten state. As such, high temperature gasifiers are prohibitively expensive and the refractories are prone to failure. As a result, they are not economical for processing biomass and general wastes in most countries and have generally only found a viable niche market in processing hazardous or medical wastes.

Another byproduct formed during gasification is char which is the solid material that forms during the initial stage of heating and pyrolysis of a carbonaceous material at temperatures between about 400 and 700 degrees Centigrade. Depending upon the gasifier design, char conversion into syngas could be low or high, though few gasifier designs achieve a char conversion that is complete (ie. 100%) in a single pass. Removing slag, ash and or char from a gasification process can be challenging.

A further challenge in gasifier design is that gasifiers are operated by limiting the oxygen required for complete combustion in order to primarily produce a low calorific or low-Btu gas (British thermal units). Accordingly, the gasifer should be sealable in use. Any openings in the gasifier, including the feeding systems, need to be sealable, and openable, and resealable. Maintaining a gas-tight sealable structure during solid waste feeding and removal is critical in allowing a gasifier to operate either continuously or be reusable over a number of cycles. This requirement is made difficult because of the simultaneous need to manage high operational temperatures and feedstock and ash of variable shape and size, with considerable abrasion potential. Complicated feeding systems using lockhoppers or screw feeders are commonly used to load fresh feedstock, however they are prone to leaks, wear and seizing.

Most continuous ash removal systems use a rotatable grate to collect and discharge solid ash and or use a water bath to maintain a gas seal and cool the ash before discharging. Patent application WO2006061738A2 (to Stadler et al.) describes a grate system for removing ash from a fixed bed coal gasifier. EP 1 687 391 (to Schilder) shows an example of a spray ring for wetting char and/or slag in a water bath. Such systems are highly complex, prone to wear and corrosion and may generate wastewater and be susceptible to steam explosions.

The challenge of reliably sealing the gasification reactor vessel during operations means most biomass and waste gasifier designs operate at close to atmospheric pressure. While some pressurised gasifier designs do exist, they are generally restricted to processing homogeneous solids in the form of pulverised coal or biomass, conveyed into the reaction vessel either as a uniform suspension of particles within an injected fluid, or mixed with water to form a pumpable slurry.

Biomass and waste feedstocks often contain a high moisture content which decreases gasification efficiency and produces wastewater after the syngas is cooled. Pre-drying of the feedstock is often performed prior to gasification using a separate drying unit such as a rotary kiln dryer. However this requires additional handling of the feedstock and increases the cost and reduces the reliability of the process.

Accordingly, there exists a need for an improved method and system for producing syngas from carbonaceous and combustible materials, particularly for mixed waste feedstocks and feedstocks that contain a relatively large quantity of inerts and contaminants. The present invention aims to ameliorate problems of methods known in the art or at least to provide a useful alternative.

### SUMMARY OF THE INVENTION

In a first aspect there is provided a method of producing a gas from a combustible material, the method comprising the steps of:
(a) loading the combustible material into a containment structure;
(b) substantially sealing the containment structure;
(c) feeding an oxidant via an oxidant injection point into the sealed containment structure and igniting the combustible material;
(d) moving the oxidant injection point from one end to the other end of the containment structure;
(e) controlling a flow rate of oxidant and a rate of movement of the oxidant injection point such that the combustible material is partly converted, thereby leaving behind thermally affected layers of combustible material in the sealed containment structure after the injection point has passed through the material;
(f) cooling and purging the sealed containment structure;
(g) unsealing the sealed containment structure to load fresh combustible material on top of the top-most thermally affected layer left behind after completing step (c) to step (e); and
wherein during step (e) at least some of the combustible material is converted into molten slag and or char that accumulates as the bottom-most thermally affected layer and subsequently cools and solidifies, the method characterised in that it further includes the step of:
discharging solid slag and or char in the bottom-most thermally affected layer from under material that remains in the containment structure to remove solid slag and or char from the containment structure; and
(h) repeating steps (a) to (g).

In prior processes, to remove ash and or slag, the entire containment structure must be emptied at the end of a gasification cycle. The containment structure is then reloaded with fresh combustible material for a new gasification cycle. In the present invention, the ash in the form of slag is removed from the bottom-most thermally affected layer while it remains in the containment structure.

A surprising result that was discovered when operating the moving injection concept of step (e) was that the inorganic (ash) materials in the feedstock can be melted by the intense and localised high temperature reaction zone, forming slag. As the gasification zone moved away from the molten slag, it cooled and solidified forming brittle agglomerates. This observation and the present disclosure of a method to discharge the slag and char at the end of the gasification cycle when the contents are cool with the mechanical solid removal system, leads to a unique gasifier design, hitherto unknown. The key features of this design are that with the moving injection concept biomass and waste materials can be processed at high temperatures sufficient to melt the ash into slag, having the advantage of forming this non-hazardous material like other high temperature gasifiers, but the slag can be readily removed at ambient temperatures, avoiding the myriad complexities and thermal inefficiencies of discharging it when it is in a molten form.

In embodiments, the present invention provides a gasifier which operates in a way that enables the ash in the waste to form a molten solid which is slag. This solid is left to cool inside the reactor and is discharged as a dry, cool solid.

In an embodiment, the step of discharging the slag in the bottom-most thermally affected layer is undertaken by at least one ram.

In an embodiment, the present invention provides a gasifier which operates in a way that enables the feedstock to be partially converted to char (which will necessarily also contain ash from the feedstock), without forming slag. The solid char is discharged in the bottom-most thermally affected layer by at least one ram.

In an embodiment, the present invention provides a gasifier which operates in a way that enables the ash in the feedstock to form slag and a portion of the feedstock to be partially converted to char. The solid slag and char are discharged in the bottom-most thermally affected layer by at least one ram.

In a second aspect there is provided a method of producing a syngas from a combustible material, the method comprising the steps of:
loading the combustible material into a containment structure having a first side and a second side arranged along either side of an elongate axis;
substantially sealing the containment structure;
optionally heating the combustible material with a heating gas to pre-dry the combustible material;
feeding an oxidant into the sealed containment structure;
igniting the combustible material in the presence of the oxidant;
moving one or more oxidant injection points for injecting the oxidant along the elongate axis of the containment structure from one end to the other, thereby partly converting the combustible material to syngas and leaving a series of thermally affected layers containing residual combustible material, char and slag;
ceasing oxidant injection and purging the containment structure with a purging gas;
circulating a cooling gas through a cooling loop to cool the contents of the containment structure;
removing one or more of the thermally affected layers containing residual combustible material, char and slag out from under other thermally affected layers that remain in the containment structure, using at least one ram operable to discharge residual combustible material, char and slag out of the containment structure by movement from the first side of the containment structure towards an openable/closable opening in the second side of the containment structure.

The description relating to the first aspect is applicable to the description relating to the second aspect, and visa versa, unless the context makes clear otherwise.

The present disclosure relates generally to gasification of a combustible material. By “combustible material” is meant any material, or any combination of a plurality of materials, from a which a gas can be produced. The combustible material may be a carbonaceous material. In suitable embodiments, the combustible material may comprise a biomass material. The biomass material may be derived from a renewable energy source such as but not limited to, a plant-derived material or an animal-derived material. Non-limiting examples of plant-derived biomass material includes grasses (such as sugarcane, switch grass, and miscanthus, although without limitation thereto), tree species (such as Cyprus, oil palm, eucalyptus, bluegum, poplar, willow, and pine, although without limitation thereto), hemp, grains such as wheat, sorghum, corn husks, legumes such as pongamia, wood pellets, lumbering and timbering wastes, and garden waste. Plant-derived biomass material may be derived from agricultural sources. Plant-derived biomass materials may include paper and cardboard. Plant-derived biomass materials may include fruits and vegetables.

Non-limiting examples of animal-derived biomass material includes sewage sludge and biosolids from waste water treatment plants and manure from animals of all types, including cows, sheep, pigs, chicken etc.

The combustible material may comprise a fossil fuel such as, but not limited to, coal or a combustible material derived from fossil fuels such as plastics. The combustible material may comprise, or be derived, from municipal waste, and it is contemplated that municipal waste may include a combination of combustible materials such as, but not limited to, a biomass material and a plastics material. In exemplary embodiments that contemplate a combustible material comprising a combination of a plurality of combustible materials, each combustible material may be in generally equal proportions, or alternatively, a proportion of one combustible material may exceed a proportion of another combustible material.

The combustible material can comprise green waste, agricultural waste, food waste, construction and demolition waste, Municipal Solid Waste (MSW), biosolids or a mix thereof. By way of example only, a combustible material may be derived from municipal waste, which may comprise about 70 wt % of a biomass material, with a fraction of the remainder being a plastics material. The combustible material may include unprocessed, irregular and/or oversized material. The combustible material can comprise at least 80% biomass material and 20% ash.

In relation to all aspects the terms “gas”, “syngas”, “synthetic gas” are used interchangeably to refer to a gas produced according to the methods of the present disclosure. The gas produced from the gasification process accordingly is particularly suitable for use in generation of power and electricity. In embodiments, the produced syngas is cleaned using conventional technologies and can either be directed to flare, combusted in an engine to produce electricity or processed further to produce high purity hydrogen. The process results in the production of syngas, the formation of thermally affected layers in the combustible material, and the formation of slag, ash and char. The ash can be fully or partially converted to slag.

The containment structure, sometimes referred to as a gasifier or a reactor, is suitably configured to receive a combustible material for the gasification process.

The containment structure may be in the form of a receptacle, a chamber, a cell, a pit, or a vessel. The containment structure according to any one of the methods or systems of the present disclosure may be rectangular in shape when viewed from above, although other shapes are contemplated. In an embodiment, the containment structure has a horizontal axis that is longer than either the width or height of the containment structure.

Each containment structure can be constructed of carbon steel. The table below, shows indicative dimensions and production capacities of three possible reactor embodiments—a pilot reactor, a containerised reactor and a large stick-built reactor. The volume of the reactors can vary significantly, starting from as little as a few cubic metres up to several thousand cubic metres. Similarly, the syngas production flow may vary from a few tens of normal cubic metres per hour (Nm3/hr) to tens of thousands and potentially even hundreds of thousands of Nm3/hr.

| | Pilot | Containerised | Stick-built |
|---|---|---|---|
| Parameter | Reactor | Reactor | Reactor |
| Length (m) | 5 | 12 | 20 |
| Width (m) | 0.8 | 2 | 8 |
| Height (m) | 1 | 7 | 20 |
| Volume (m3) | 4 | 168 | 3,200 |
| Feedstock converted (tpd) | 0.5-1 | 25-50 | 500-1000 |
| Syngas production (Nm3/hr) | 50-100 | 2,500-5,000 | 50,000-100,000 |

The walls can be insulated with many types of common insulating materials and lined with steel or refractory. The lining can be a low alumina refractory brick and calcium silicate insulation board. The design can predominately use the feedstock to self-insulate the sidewall thereby limiting the sidewall temperature and preventing slagging and overheating. The majority of the containment structure is expected to experience temperatures around 100-200 degrees Centigrade though the gasification front is assumed to reach approximately 1500 degrees Centigrade when operating on pure oxygen as the oxidant. At commercial scale, the containment structure can be constructed using modules based on standard shipping container dimensions. In an embodiment, the containment structure is constructed from 2 or more 40 ft high cube containers stacked vertically.

The containment structure can be used for the gasification of various waste feedstocks into synthesis gas (syngas). The design capacity of each gasifier can vary anywhere from 0.5 tonnes per day (tpd) to 1000 tpd of feedstock. When the process is scaled up, there could be up to 500 or 1000 (or more) tonnes of waste processed per day.

In order to load the containment structure, the lid is opened and the combustible material is loaded manually or using any suitable type of mobile or fixed material handling plant. Suitable means for loading can include but not limited to excavators, material handlers, front end loaders, cranes, telehandlers, forklifts, conveyors or rails. The combustible materials can be handled directly or using bins. Optionally, the containment structure is purged with air prior to loading.

Once combustible material is loaded into the containment structure, the lid can be closed and sealed. The seal is important because a gasifier is operated by limiting the oxygen required for complete combustion so it is critical that oxygen from the outside air cannot enter into the containment structure during the gasification process. The seal can be any means that allows for an internal pressure of up to about 1, 2 or 3 kPag. The seal can be a liquid seal. A liquid seal provides a liquid barrier between the inside of the containment structure and the surrounding atmosphere. In operation, the reactor operates at near atmospheric pressure. The reactor lid can close into a water seal trough located on the inside of the containment structure which can provide the airtight seal. The liquid seal prevents gas from escaping or air from entering the structure.

In an embodiment, after the containment structure is sealed and before gasification commences there can be a step of heating the combustible material with a heating gas to remove moisture from the combustible material. The step of heating the combustible material with a heating gas to pre-dry the combustible material is optional. However, in a preferred embodiment, the method includes the step of heating the combustible material with a heating gas to pre-dry the combustible material.

The heating step may be conducted with air if the presence of air at the heating temperature does not introduce a risk of starting combustion or smouldering reactions in the feedstock. If a risk exists, an inert heating gas such as nitrogen or carbon dioxide may be used. Nitrogen is selected by default as it can be produced readily by nitrogen generator. Prior to heating, in one embodiment, the air within the containment structure can be purged to atmosphere via the safety vents using an inert gas such as nitrogen.

The combustible material feedstock can then be dried in-situ using a heating gas in a closed loop circuit. The heating gas may be delivered at a temperature in the range of from about 75 to about 150 degrees Centigrade. In this circuit the heating gas can be heated and then passed through the bed of combustible material feedstock. In a preferred embodiment the heating gas is injected at the bottom of the containment structure and removed from the top, above the level of the feedstock. In an embodiment the heating gas is injected part the way up the containment structure, while in another embodiment the heating gas is injected from one side of the containment structure and collected on the opposite side of the containment structure. The moisture laden gas leaving the reactor can be cooled to condense out the moisture that was picked up from the feedstock while passing through the containment structure. With the moisture removed, the gas can be re-heated and recirculated using a heater and blower.

If the combustible material loaded into the containment structure has a low moisture content, then drying may not be required. A low moisture content material can be refuse derived fuel (RDF). The RDF can be roughly about half paper derived material and half plastic material with a heating value about 30 MJ/kg (ie. half way between biomass at 20 MJ/kg and plastic at 40 MJ/kg).

MSW on the other hand, generally has 25-30 wt % moisture, due to presence of food waste which has a high moisture content, and the MSW is typically contained in plastic bags. An advantage of the closed loop drying system from this disclosure is that it may serve a dual-purpose, namely, heating the plastics bags to a sufficiently high temperature that they soften and open up, exposing the contents and thereby enabling effective drying of the full contents of the MSW feedstock. This dual-function relies on the use of an inert heating gas at a sufficiently high temperature, about 150 degrees Centigrade or more. The integrated closed loop drying system therefore eliminates the need for several pre-treatment steps that would usually be performed by dedicated equipment, such as opening up the plastic bags, shredding the feedstock and drying the feedstock.

Prior to commencement of the gasification step, the reactor must be purged of oxygen using an inert gas, such as nitrogen or carbon dioxide. If the heating step was conducted with air, then a separate purging step will be required. If the heating step was conducted with nitrogen or carbon dioxide then the reactor will already have been purged of oxygen. The oxygen level in the reactor is checked by measuring the composition of the purge gas exiting the reactor or the composition of the recirculated gas.

The oxidant delivered to the containment structure during the gasification process can be fed into the sealed containment structure by one or more injection members or lances. Each injection member can be configured to include a plurality of oxidant outlets each arranged to carry a flow of an oxidant.

The oxidant injection member can be positioned along at least a portion of a base of the containment structure. Alternatively, the oxidant injection members are inserted within the bed of combustible material in the containment structure. In an embodiment, the oxidant injection member is a solid retractable pipe or lance which injects oxidant from an end part and optionally at locations along the pipe. The pipe or lance can be retracted through the containment structure during gasification operations to provide a moving thermal front.

In large containment structures, multiple injection members or lances may be used simultaneously. The lances may be arranged in a pattern, with lances spaced apart vertically and horizontally to evenly spread out the oxidant outlets so that they cover a large portion of the cross-sectional area of the bed formed by the feedstock. In a large containment structure there may be anywhere from 1 to 50 lances.

Prior to the commencement of the gasification operations, the lance or lances will normally be positioned in the “fully retracted” position, with the oxidant outlet nozzles positioned at the far end away from the syngas outlet pipe. This is the position, at which gasification operations were stopped in a previous batch cycle. Prior to the start-up procedure, the lances will be moved to the “fully inserted” position. The lances will be pushed into the reactor using hydraulic rams, rollers or a rack and pinion system located outside of and at one end of the reactor. At the fully inserted position, the lance tip, where the oxidant outlet nozzles are located, is close to the syngas outlet pipe, but sufficiently far from it to ensure there is ample feedstock between the lance tip and the outlet pipe for the start up procedure.

The lances are preferably located in the bottom third of the reactor, where after several batch cycles of operation, the feedstock has been thermally affected to form char particles, which are small and highly permeable. As such, it is not difficult and very reliable to push the lances into the fully inserted position using hydraulic rams or other methods.

During normal operations, the lances are retracted by the hydraulic rams or other suitable methods, at a defined interval of time. The interval may be fixed or it may be varied by the process control system based on the oxidant injection rate and other factors.

In principle, when multiple lances are utilised they may be retracted independently or as a group. In a preferred embodiment the lances are retracted as a group to limit the complexity of the mechanisms used to push and pull the lances. In another preferred embodiment the lances are formed into several groups, and the lances of each group are then retracted together using a single retraction mechanism.

In an embodiment, the oxidant for gasification will be primarily pure oxygen supplied from an air separation unit. The design can allow for oxidant mixes of air, enriched air, or steam with oxygen, air or enriched air. The oxidant's composition and flowrate can be controlled via flow injection valves. As the reactors operate on a batch process there are some distinct stages for their operation.

In an embodiment, the method further comprises the step of controlling a flow rate of oxidant and a rate of movement of the oxidant injection point such that the combustible material is partly converted, thereby leaving behind an unconverted, thermally affected layer of combustible material in the sealed containment structure after the injection point has passed through the material. This moving oxidant injection concept is the subject of applicant earlier publication WO2017205943 filed on 5 Jun. 2017 entitled PRODUCTION OF A GAS AND METHODS THEREFOR the contents of which are hereby incorporated in their entity by reference. Any conflict with the disclosure of WO2017205943 and the present disclosure should be resolved by reverting to the present document as the one which takes precedence.

Following gasification, it is desirable to cool the contents of the feedstock in the containment structure, so that upon any contact with air (during the unloading step), the feedstock does not spontaneously ignite. It is also desirable to purge all of the syngas from the containment structure, to ensure these components are recovered as much as possible as the product, and to prevent (or reduce) them from being emitted directly to the atmosphere, which would occur if the purging step was not undertaken. An inert gas such as nitrogen or carbon dioxide can be used to cool and purge the contents of the containment structure.

While the cooling and purging step is undertaken in one reactor, the resulting gas, which will be a partially diluted syngas, can be bled into and mixed with the product gas from a parallel reactor which is currently operational as a gasifier and producing a steady stream of syngas.

The rate of injection of the inert gas during the cooling and purging step can be controlled such that the inert content (nitrogen or carbon dioxide concentration) of the syngas resulting from the mixing of the two reactors is below a limit, typically set by the specifications required of a downstream user of the syngas. For example, in the case of the use of gas engines, the downstream syngas shall meet a minimum heating value. For example, in the case of the production of hydrogen via separation from syngas in pressure swing adsorption unit, there will be a maximum nitrogen content above which the purity requirement of the hydrogen cannot be met by the pressure swing adsorption (PSA) unit.

The cooling and purging step can aim to achieve the following conditions in the bed:
syngas component concentration below 1%; and
bed temperatures below the auto-ignition or smouldering temperature of the feedstock when exposed to air.

The cooling and purging step can use the same equipment as the heating step, with the heater not used and a cooler used to cool the resulting dilute gas to a low temperature close to or below ambient temperature. In an embodiment the cooling step may be achieved by recycling cold syngas to the containment structure and then an inert gas can be used to purge the syngas from the containment structure.

After the cooling and purging step with an inert gas is complete, then purging with air can be commenced in preparation for opening the reactor to atmosphere.

During gasification, combustible material is exposed to high temperatures which (in addition to forming gases) can result in melting of ash to form slag which agglomerates and solidifies inside a thermally affected layer.

The solid agglomerates formed can comprise one or more of ash, slag and char. Typically slag forms into agglomerates and large particles, while the char forms into fine particles. The solid material can comprise slag pieces with dimensions of the order 1, 5, 15, 30, 50, 80 or more cm. The slag in the containment structure melts and separates out during processing and after gasification to form a bottom layer in the containment structure. The slag as it cools tends to form brittle agglomerates, while the char is a fine powder. The slag agglomerates tend to break apart easily just by handling them and during removal of them from the reactor.

After removing the slag-containing layers, the solidified slag can be separated from the residual combustible material and or char or biochar. The agglomerated pieces of slag are much larger than the other particles so the separation can be undertaken by a screening device. The residual combustible material and or biochar can be returned to the process along with the fresh combustible material.

By returning biochar back to the reactor, the process may be able to achieve substantially full carbon conversion of the feedstock. Depending upon the quality of the biochar and the market situation, the biochar could also be used for other purposes. For agricultural feedstocks, which are not contaminated, with molecules such as heavy metals, the biochar could be returned to the field and be used to sequester carbon. For MSW and other contaminated feedstocks, the biochar could be safely sequestered into asphalt.

In embodiments, the present system has the flexibility to either fully convert carbon or have a partial carbon conversion and produce biochar. In particular, operators can process a contaminated feedstock one day with full carbon conversion into syngas product and produce slag as a co-product, while the next day they could process agricultural residues and produce biochar as the co-product. For operators this would provide a great deal of flexibility since they can choose which feedstocks to process based on market conditions.

This operational flexibility is made possible by the herein disclosure of the novel combination of the moving injection system for the oxidant outlets which generates a slag at high temperatures which is solidified to form agglomerates and the hydraulic rams to enable removing the bottom-most thermally affected layer in the containment structure. It is noted that existing gasifier designs do not enable this operational flexibility as they are designed to produce either solidified ash or molten slag and therefore cannot process a wide range of feedstocks from day to day, nor produce a wide range of co-products (slag and/or biochar) from day to day either.

In any case, in embodiments, it is desired that there will be zero waste to landfill from the present process.

Periodically, the method includes opening the containment structure to reload fresh combustible material. The fresh material is added onto the top of any material already in the containment structure. In an embodiment, the material to be loaded into the containment structure may be compressed either before or after it has been loaded, in order to increase its bulk density and hence the total mass of material that can be loaded into the containment structure. Any known means of compressing biomass and waste materials may be used. After the fresh combustible material has been added to the containment structure, the containment structure is sealed and the sequence of steps of the gasification process are repeated.

It should be understood that the gasification process can be repeatable by the addition of new combustible material without the step of removing the bottom-most thermally affected layers. When the slag and char accumulates to an extent that it either requires removal, or removal is desired, then the discharging of the bottom layers can be undertaken.

Slag is formed during the gasification process in quantities based on the ash content of the feedstock. The high local temperature during gasification causes the ash to melt and upon cooling form a slag layer near the bottom of the bed.

The prior process required manual removal of ash or slag by completely emptying the contents of the gasifier. The present process allows a different means for removing slag and or char that has resulted in considerable redesign of the containment structure and process for its operation. The means for removing slag and or char is a mechanical removal system that operates after the gasification process and can selectively remove the slag-containing layers near the bottom of the gasifier. When operating the present system significant time savings and operational benefits can be achieved which represents a commercial advantage to the operator.

It should be clear to those skilled in the art, that during normal operations, the bottom-most layer in the containment structure will predominately consist of slag and or char. However, depending upon operating conditions, the solids in the bottom-most layers may also contain or may only contain partially converted feedstock, slag, ash, and char. In commissioning operations, virgin, unreacted feedstock may be unloaded from the containment structure. When the containment structure is operated only as a drier, dried feedstock may be unloaded from the containment structure using the mechanical solid removal system.

The mechanical solid removal system comprises one or more rams associated with the containment structure. The containment structure can have a top surface where the lid is located, side walls and a bottom surface. The or each ram can be located adjacent to the bottom surface of the containment structure. The or each ram can be movable into the containment structure so as to shift, move, push, transfer or discharge material from the bottom layer of the containment structure. The or each ram is configured to move forwards into the bed of material and backwards into a housing. The housing can form part of the containment structure and must be gas-tight, or it can be external to the containment structure.

The ram can have a top surface, an optional bottom surface and a ram face. Since the ram has to move through the material and then is retracted once the layer has been ejected, the top surface of the ram is preferably a support surface. As the ram moves forward the material not discharged from the containment structure will rest on the support surface. As the ram is retracted the thermally affected material including combustible material will move off the support surface and drop under gravity to the bottom of the containment structure.

The rams can each be located on a first side of the containment structure. There can be one or more openings in the first side of the containment structure which allow passage of the ram into the containment structure. Optionally, when the ram is not in use, the openings in the first side of the containment structure can be sealed e.g. by a retractable door. The door can be openable to allow the ram entry into the containment structure. The door in the first side of the containment structure can be operated using electronic circuitry. It may be desirable to seal the openings on the first side of the container when the ram is not in use to protect the ram face from the gasification process. Alternatively, the ram face can itself become the seal for the opening in the first side of the containment structure, whereby a ram face aligns flush with the opening and forms a part of the containment structure wall.

There can be one or more openings on the opposite side of the containment structure, the second side, through which the solids are discharged. The or each ram can transfer forces to the solids in the bottommost layer which is ploughed towards the openings in the second side where it is then discharged. There can be one long opening or there can be a plurality of smaller openings. Each opening can be associated with a ram. In some embodiments, if there are multiple openings, the wall provided between each opening can be shaped like a wedge. The wedge can extend inwardly of the containment structure and can serve the function of directing the solids to the opening, and or breaking up larger pieces of solids such as slag that are impaled on the wedge surface.

To assist in discharge of the solid waste, the or each opening in the second side of the containment structure can be associated with a passageway or chute which takes the solid waste by gravity to a bin, a conveyor or other collection means. The passageway or chute associated with the openings in the second side of the containment structure can be covered over the top part of the opening to prevent or reduce the chance that discharge solid waste will disperse into the atmosphere as it is ejected.

Each opening in the second side of the containment structure must have a door. The door must be openable and closable. In the closed state, the door must provide a seal so that the gasification process is also able to proceed. Providing a door and a chute/covering over the chute can be a challenge because there are multiple components that are all arranged in the same space. It is not desirable for the door to be at the end of any chute passageway, because the interior area of the containment structure is best kept as small and tight as possible during gasification. Accordingly, preferably the door is in line with the second side of the containment structure so that once closed it is flush with the wall of the containment structure. In an embodiment, there is a hinged door which extends out of the chute when open but which can move upwardly and into the chute when the door is closed for gasification. The door can be complementary in shape to the interior of the chute. The door can have a trough which upon swinging inside the chute allows for a liquid seal around the outside edge of the door. The inward facing surface of the door can be insulated and or covered with a refractory, ceramic or steel liner to protect the door from exposure to the high temperatures of gasification.

Preferably, the ram face is a flat area which is able to apply force against the solids in the bottom-most layer, forcing it into the direction of travel of the ram. The or each ram can be operated manually. The or each ram can be operated automatically. The or each ram can be operated hydraulically. The or each ram can be mounted on one or more hydraulically operated pistons. The ram face can be pushed by the piston. The ram face could, in principle, be pulled by the piston which would have the effect of pulling the solids towards the opening in the second side of the containment structure. While this could be performed, it should be understood that the piston would then be located in the containment structure which may not be desirable. Each ram can have an operating pressure up to about 200 to 300 bar. Each ram can deliver a force of up to about 100 kN per cylinder. This could increase by 5 to 10 times for a very large reactor. The force delivered by the rams needs to be sufficient to penetrate into the solid material and move the lower layers thereof under the influence of the rams movement. The combustible material once subject to gasification can be a heavy mass in the containment structure and movement of one bottom layer of it will require significant forces. Furthermore, the force asserted by the rams needs to be sufficient to allow for the retraction of the ram once the discharge has been effected. In a preferred embodiment two pistons are used to move each ram.

The amount of the slag and or char that is discharged will depend on the area of the ram face. The larger the ram face, the more solids will be discharged. Similarly, the wider the opening in the second side of the containment structure, the more solid can be discharged. The height of the ram face is a key consideration in the design of the mechanical solid removal system. A smaller height will require less hydraulic force to move the ram, but may require multiple strokes of the piston and ram in order to discharge the desired amount of solid material after each gasification step. On the other hand, a greater height will require more hydraulic force to move the ram and fewer strokes of the piston and ram to discharge the desired amount of solid material.

In one embodiment, the height of the ram face measured from the bottom surface of the containment structure to the top surface of the ram is selected or optimised to discharge about 5% to 10% of the material in the containment structure on each stroke of the piston, and more preferably around 10%. In an embodiment, the height of the ram face is at least equal to height of the slag agglomerates that form after gasification. In an embodiment, the height of the ram face is at least 25, 40 or 60 mm.

It should be obvious that when multiple lances are arranged in the vertical direction, and the feedstock is a high ash material, that the piston and ram may need to be stroked multiple times to completely remove all of the slag produced during the gasification cycle.

The ram face can be a flat plate. The ram face can have a shape which assists in discharge of waste. In an embodiment, the ram face can be plough shaped, with two plates meeting at a point in the middle. The ram face can have surface patterns or undulations that assist in collecting up fine particles or capturing larger particles by friction and carrying with the ram face as it traverses the containment structure in operation.

There can be one ram moving from a first side of the containment structure to the second side of the containment structure. Where the containment structure is elongate with a pair of longitudinal sides and two shorter sides, the first side and second side can be the pair of longitudinal sides. It may be advantageous to arrange the rams to be movable from one of the longitudinal sides to the other, because the pathway over which the ram has to travel is relatively shorter. However, there are advantages if the rams can be operated between the pair of short sides, since there will inevitably need be fewer rams or even just one ram to discharge the solid material. However, with a ram running from one of the short sides to the other of the short sides, the pathway that the rams would have to advance and retract would be longer, which may present operational issues.

There can be a plurality of rams each ram existing alongside the other. In an embodiment, the number of rams in each containment structure is between 1 and 10, and more preferably between 2 and 6, and optimally between 3 and 4.

It should also be understood that when multiple rams are employed, they may be operated together as a single unit, or operated independently in a sequence.

The dimensions of the reactor will influence the size of each ram. In a pilot reactor, each ram can be at least about 0.5, 0.8 or 1m across the width of the ram face. Where the ram is about 1m in width and the containment structure side is about 6m there could potentially be 6 rams along the bottom of the containment structure. However, it should be understood that mechanically there is a need for spacing required between each of the rams to allow for their mechanical movement, and to provide space for whatever sealing method is used to ensure that the containment structure remains sealed from the outside atmosphere during operation. Preferably, the rams are as close to one another as possible when arranged side by side to avoid any area on the containment structure floor that is not coverable by the rams passage from one side to the other. Therefore, in an embodiment of the pilot reactor four rams may be used. In one embodiment of a containerised reactor, four rams may also be used, with a ram width of around 2.5 to 4m each. In another embodiment of a stick-built reactor, six rams may be used, with a ram width of around 3m each.

In an embodiment, at least about 80, 85, 90, 95 or 99% of the bottom floor of the containment structure is coverable by ram movement.

The rams can all move from the first side of the containment structure to the second side of the containment structure. Alternatively, some of the rams move from the first side of the containment structure to the second side of the containment structure, while others of the rams move from the second side of the containment structure to the first side of the containment structure. Optionally, the rams alternate in their direction of travel along the length of the containment structure. An advantage of alternating the passage of the rams could be that any solid waste not captured or diverted by one ram could be collected by its adjacent ram running in the opposing direction.

It should be understood that functional equivalents to the rams described could also be used. For example, instead of a ram with a ram face that moves into and out of the containment structure, the floor of the containment structure could be a movable shelf. The shelf could have a wall along one side which acts as the ram face. Upon actuation of the ram face to move forwards, the whole lower part of the bottom-most layer is moved out from under the other layers of thermally affected material. As the shelf extends from the containment structure a mechanism for scraping the solids from the shelf can be provided before the system is retracted.

In embodiments, the ram can inject gas into the containment structure when it is stationary, moving or in any position. The gas can be air, carbon dioxide, nitrogen or syngas. The gas can be used for heating, cooling or purging. The ram can be used to inject the gas at different positions depending on the ram position in order to distribute the gas throughout the containment structure.

In an embodiment, the ram comprises one or more openings to inject the heating gas, the purging gas and or the cooling gas into the containment structure. In an embodiment, the ram comprises one or more gas injectors for injecting the cooling and purging gas, thereby the ram is used to cool and purge the sealed containment structure. Furthermore, the one or more gas injectors of the ram can be used in any heating step for heating the combustible material thereby drying the combustible material prior to conversion.

In an embodiment, where there are openings for injecting heating, cooling or purging gas, the openings can be located in the ram face. When not in use, the face of the ram can be retracted to the inside wall of the containment structure to reduce the face temperature during gasification operation.

In an alternative embodiment, there are one or more gas injectors in the containment structure for cooling and purging and or for heating, but these are not located on the or in each ram and instead are remote from the rams. The gas injection members could be located on the floor of the containment structure underneath the rams. The gas injectors operating as injection members for cooling, heating and or purging gas would have a plurality of outlet holes through which the heating, cooling or purging gas are distributed across the length of the injection member. Further, the outlet holes are sized to ensure an even distribution of gas flow into the containment structure.

In an embodiment, in order to prevent solids in the bottom most layer of the bed from entering into the gas injectors through the outlets when the heating, cooling or purging gases are not being injected, the outlets may be positioned on the sides or on the bottom of the gas injectors. In addition, in an embodiment, a cover could be located over the gas injectors so that solid material, especially char particles, particulates and condensing tars can not accumulate in the gas injectors and block the flow of heating, cooling or purging gases into the containment structure.

If gas injectors are placed in or on the floor of the containment structure then they will need to be designed appropriately and made of materials that can withstand high temperatures and abrasion from the solid materials as they are pushed by the rams in the vicinity.

As the reactors operate on a batch process there are some stages of operation. These stages of operation are “Loading”, “Heating and Purging”, “Gasification (or Producing)”, “Cooling and Purging”, “Purging with Air” and “Unloading”. An exemplary embodiment of the process is now described:

### Loading Stage

During the loading stage, the containment structure is loaded with combustible material to form a bed of feedstock. Prior to loading, the containment structure is purged with air. The loading may be achieved by using a material handler with a grapple attachment, which is used to grab a volume of combustible material from a storage pile in the vicinity of the containment structure and lift it over the opening created by the lid and then release it into the containment structure. Or the combustible material may be loaded using conveyors, cranes or bins or any other means.

### Heating and Purging Stage

With the reactor lid closed and sealed, the reactor is ready for the heating stage, where the objective is to heat and dry the feedstock to reduce its moisture content. Inert gas is used to optionally heat and dry the feedstock and also to purge the containment structure of any oxygen. In some circumstances air may be used as the heating gas. In this case, an inert gas such as nitrogen will be subsequently used to purge all of the oxygen from the containment structure. In a preferred embodiment, an inert gas is used and heated and circulated in a closed-loop system to dry the feedstock.

### Gasification (Producing) Stage

Once the bed is dried and purged of oxygen it is ready to start producing syngas. The oxidant injection lances will be moved from the “fully retracted” position to the “fully inserted position” in preparation for ignition. Ignition of the bed inside the reactor can be initiated via a heater in the oxidant injection member or lance. In an embodiment, while this heater is on, pure nitrogen is flowed through the oxidant injection lance and once the required ignition temperature is reached, the nitrogen flow is replaced by the required oxidant being pure oxygen, air, enriched air with or without steam impregnation for gasification by slowly ramping its flowrate up. As gasification of the bed proceeds in the vicinity of the tip of the lance, the injection lance is retracted semi-continuously to enable gasification of the feedstock from one end of the containment structure to the other.

The pressure in the containment structure during operation can be controlled via a pressure control loop which modulates the syngas blower's speed. The operator can select which reactor is in production mode using a selector block on a control panel. This defines which pressure transmitter will be used in the pressure control loop. Individual safety vents can be connected to each containment structure reactor. The vents can have a 30 mm water seal height (or more) above the vent pipe dip leg which provides the over-pressure protection for the reactors.

During an extended run a series of parallel containment structure reactors can continuously rotate through the stages of operation to allow the continuous production of syngas. The raw syngas leaving the production side of the containment structure reactor can be passed through gas clean-up equipment to process the syngas to reach specifications suitable for use in downstream applications, such as electricity production via a gas engine or purification and separation of hydrogen or the synthesis of new chemicals or fuels such as methanol, synthetic methane or sustainable aviation fuel using catalytic reactors.

In an embodiment, the syngas leaving the containment structure is at a temperature of 200 to 500 degrees Centigrade. The temperature of the syngas depends on the oxidant used, the composition of the feedstock, the size of the containment structure and other factors. The temperature of the syngas may be as low as 65 degrees Centigrade or may be as high as 650 degrees Centigrade.

Technologies to clean syngas at moderate temperatures are well known and appropriate technologies can be readily selected by those skilled in the art. If the syngas temperature is much greater than 80 degrees Centigrade, then it may be cooled by a liquid quench system which is simple and robust to implement. The gas clean-up equipment can be comprised of a wet electrostatic precipitator (ESP), syngas blower, syngas cooler, sulphur removal bed and activated carbon bed. The ESP can remove heavy tar droplets and particulates from the syngas stream which are condensed and may be returned to the reactor for conversion into syngas. The syngas blower can control the pressure in the producing reactor by drawing its syngas through the ESP. It can slightly compress the gas to nominally 2 kPag to generate the required pressure to flow the gas through the syngas cooler and adsorbent beds and be at a positive pressure for use in subsequent downstream applications. The syngas cooler further reduces the syngas's temperature to around ambient conditions and collects any additional condensates that form due to this temperature change. The activated carbon bed can remove impurities such as heavy metals and halide compounds hydrogen chloride (HCl), chlorine (Cl₂), fluoride (F). The sulphur removal bed preferentially removes sulphur compounds such as H₂S.

It is well known to persons skilled in the art, that different syngas cleaning methods are selected depending upon the concentration of contaminants in the syngas and the required purity for the syngas for the chosen downstream application. Different syngas cleaning methods will also be chosen based on the scale of processing. Some methods work well at low temperatures and atmospheric pressures, while other methods work well at high temperatures and/or higher pressures. In general syngas cleaning methods for syngas derived from waste feedstocks must be able to manage light and heavy tars, sulfur, chlorine, heavy metals, volatile organics and dioxins/furans.

### Cooling and Purging Stage

Once gasification is complete, the feedstock is cooled and purged of syngas by circulating an inert gas such as nitrogen. The syngas from the cooling and purging stage of one reactor can be mixed with the product syngas from another reactor currently operating to produce syngas via gasification. The degree of cooling, shall normally continue until the material remaining in the containment structure has reached a temperature below which it will not start to combust or smoulder once exposed to air at ambient temperature.

Purging with Air Stage

Once the contents of the containment structure have been sufficiently cooled, then air can be injected into the reactor and purged through the vents and or the closed loop gas circuit. The purging with air will continue until trace elements, such as carbon monoxide are below a threshold concentration, typically equal to or less than 1 vol %.

### Unloading Stage

If solid removal is desired at this time, then once the containment structure has been purged with air, the containment structure is unsealed and the waste removal system can be activated. The openings in the second side of the containment structure are opened. The rams are then each actuated to move out a layer of the bottom-most solid material which is discharged.

Multiple containment structure reactors can be run in parallel. Each can be designed to operate together with another as a continuous process. One or more reactors will be in Gasification (Producing) mode converting feedstock material into syngas, while the others are progressing through the sequence of steps of Loading, Heating and Purging, Cooling and Purging, Purging with Air and Unloading in preparation for them being placed into Gasification (Producing) mode after they reach the Heating and Purging Stage.

Thus, in a third aspect there is provided a system for the gasification of a combustible material to produce a gas, the system comprising:
a plurality of sealable containment structures, each having a first side and a second side arranged along either side of an elongate axis, each containment structure configured to operate the method of the first or second aspect of the invention, each containment structure loadable with a combustible material during a loading stage to provide a loaded containment structure;
each dried containment structure configured to produce syngas by gasification during a producing stage,
each containment structure configured to have solid material removed during an unloading stage,
wherein the plurality of sealable containment structures are operable at the same time so that at any one point in time a first containment structure is in the producing stage, while a at least a second containment structure is completing the stages, so that syngas can be continually produced from the plurality of sealable containment structures.

Optionally other stages that can be included comprise:
each loaded containment structure can be purged and dried during a heating and purging stage to provide a dried feedstock in the containment structure prior to producing syngas; and
after the producing stage each containment structure can be purged and cooled during a cooling and purging stage.

Each reactor can have an injection side and a production side. At the injection side the injection lance can be installed which is connected to the oxidant injection skid through a flexible hose connection. This flexible connection allows for the intermittent or continuous retraction of the oxidant injection lance as the gasification reaction proceeds, enabling moving injection horizontal gasification (MIHG). This retraction moves the gasification zone backward to access fresh material. A hydraulic system with a controller can be used to set the distance and frequency of the retraction. The displacement of the retraction can be measured and recorded for information.

At the production side of the reactor the raw syngas pipe connects the reactor to the gas clean-up equipment.

The syngas production rate from the MIHG containment structure reactor depends on the oxidant injection rate, oxidant composition and feed material composition. However, by connecting the production flowrate signal to the oxidant flow ratio controller, the oxidant rate can be adjusted so as to maintain a set production rate of syngas.

The syngas quality can be monitored using an online analyser. The sample point can be located on the common raw syngas line at the containment structure reactor outlet upstream of the gas cleaning unit. To condition the syngas prior to feeding it into the online analyser it can be equipped with automated gas conditioning bubblers and filters. This analyser can measure the compositions of CO, H2, CO2, O2 and CH4 in real time. The output of this analyser can be fed into the controller for trending and control operations. The oxygen concentration at the discharge of the gasification reactors is a key safety parameter to avoid a flammable mixture forming in the system.

Temperature profiles throughout the containment structure can be monitored by thermocouples. Thermocouples can be placed in the wall of the containment structure or they may be moveable and insertable into the bed of feedstock. In an embodiment, there can be as many as 18 thermocouples spaced throughout the length of the MIHG reactor structure. There can be 3 sets of 3 thermocouples per reactor side located at the top, middle and bottom of the reactor. These will provide temperatures associated with the roof, side wall and bottom at three intervals along the length of the containment structure. A thermocouple on the oxidant lance can also be used to confirm ignition and monitor oxidant injection. A thermocouple on the syngas outlet pipe can be used to confirm the temperature of the syngas which is important to keep above a minimum value in order to prevent any heavy tars from condensing and forming a blockage in the pipe.

### BRIEF DESCRIPTION OF THE DRAWINGS

Embodiments of the invention will now be described with reference to the accompanying drawings which are not drawn to scale and which are exemplary only and in which:

FIG. 1 is a process flow diagram showing the steps in a process according to an embodiment.

FIG. 2 is a side view of a containment structure according to an embodiment.

FIG. 3 is a side view of the structure of FIG. 2.

FIG. 4 is a perspective view of an embodiment.

FIG. 5 is a top view of the containment structure of FIG. 2.

FIG. 6 is a side view schematic of an embodiment.

FIG. 7 is a side view schematic of an alternative embodiment.

FIG. 8 is a schematic of the temperatures in the embodiment of FIG. 2 during production.

FIG. 9 is a process flow diagram according to an embodiment.

FIG. 10 shows an operating diagram for an embodiment in which two gasifiers are running in parallel.

### DESCRIPTION OF EMBODIMENTS

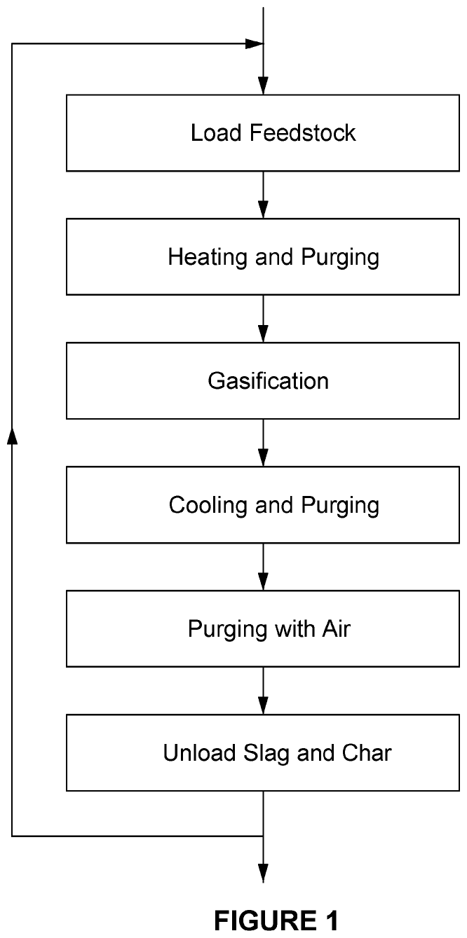

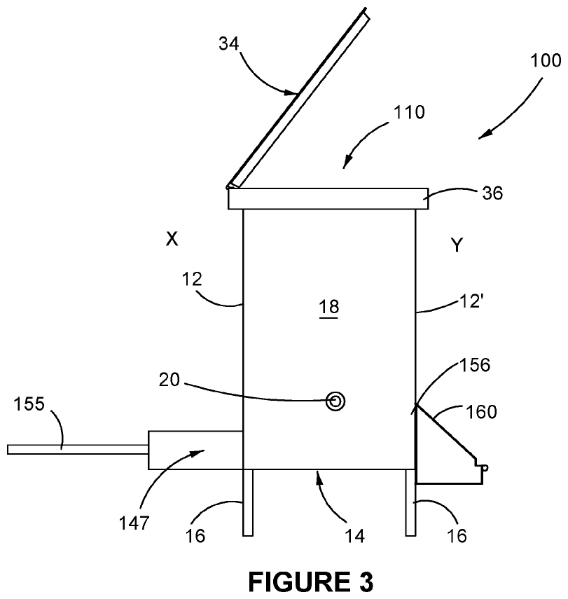

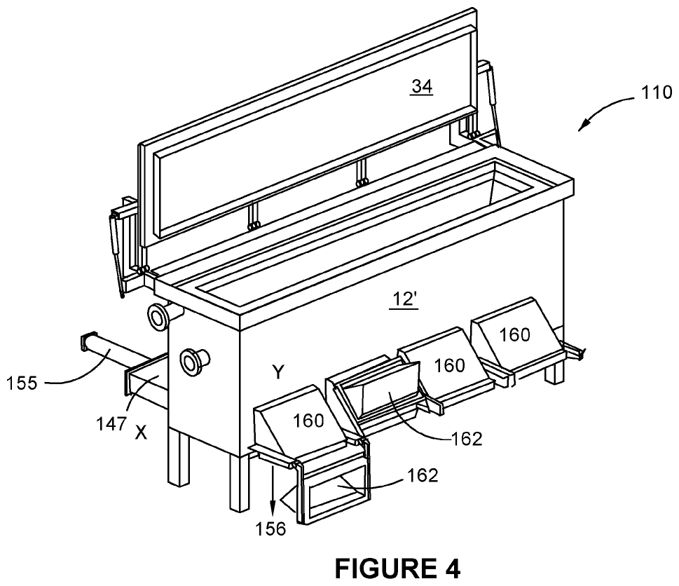

The present disclosure includes a batch method to gasify a material by injecting air or oxygen into a confined volume of carbonaceous material which can be biomass and collecting the product gas. According to an exemplary embodiment in reference to FIGS. 1 to 10, the method includes loading, which may include collecting and storing, a carbonaceous material or combustible material 18 such as biomass in a containment structure 110. In addition to biomass, the feedstock may be any applicable material or mixture thereof as described earlier in this disclosure.

Referring to FIG. 1, there is shown the main operational stages of the containment structure. The stages include the sequence of:
1. Loading the feedstock
2. Heating and Purging the containment structure with an inert gas
3. Gasification of the feedstock using the moving injection system to produce syngas continuously
4. Cooling and Purging of the containment structure
5. Purging the containment structure with air
6. Unloading slag and or char using the rams

In an industrial setting the operational sequence is repeated over and over to convert the desired quantities of feedstock into syngas and slag and char. When two or more containment structures are operated as a system, continuous syngas production is possible.

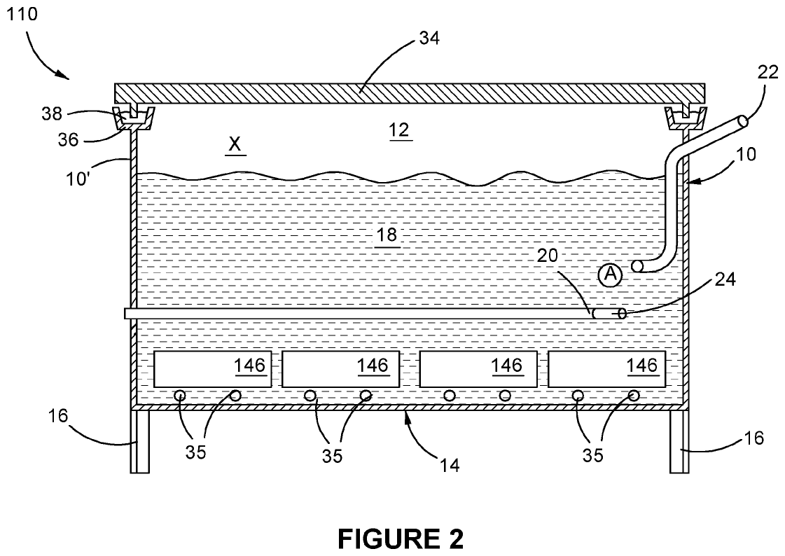

Referring to FIGS. 2 to 9 for an example of a system 100 including a containment structure 110 configured for producing a gas from combustible material 18. The combustible material 18 may be loaded into the containment structure 110 in an as-received condition or processed by chipping, grinding or compaction to increase the bulk density and homogeneity of the feedstock. The combustible material 18 may include unprocessed, irregular and/or oversized material. It will be appreciated that the combustible material 18 may include other components such as water or small amounts of other particulate material. By-product liquids 134 separated from the syngas may also be recycled and mixed with the combustible material 18 prior to gasification.

The containment structure 110 can be a long rectangular container. The containment structure can have a pair of short sides 10 and 10′ and longitudinal sides 12, 12′. The longitudinal sides are so named because they run along a longitudinal axis of the containment structure 110. The containment structure 110 also has a base or bottom or floor 14. The containment structure 110 will typically be located on a solid surface such as the ground. It can be fabricated from common engineering materials including steel, concrete and refractory. There can be one or more legs 16 to elevate it from the ground if required.

The dimensions of the containment structure 110 will depend on the required volume. A larger containment structure will provide a longer run time however the capital cost will be higher than a smaller structure. Typical storage volumes for the containment structure 110 can range from about 100 m3 to about 10,000 m3. Typical run times can range from about 1 day to about 1 week, although without limitation thereto. Typical dimensions for commercial sized containment structure can range from a width of about 2 metres to about 10 metres, a height or depth of about 2 metres to about 20 metres and a length of about 6 metres to about 40 metres.

The system 100 includes an oxidant feeding mechanism 20, in the form of an injection member 20 configured to feed or inject an oxidant into the containment structure 110. Suitably, the oxidant is fed into the sealed containment structure, to contact the combustible material 18 at multiple points in a sequence. The injection member 20 may be a duct, a conduit, a pipe, a tube, a channel, or the like. The injection member 20 may be in the form of an injection lance 20 having an injection end or tip 24. The injection lance 20 is preferably inserted in the combustible material 18 and is aligned along the axis of the containment structure 110. The oxidant is fed into the sealed containment structure 110 to contact the combustible material 18 at multiple points in a sequence. Depending on the width and height of the containment structure 110, multiple injection lances 20 may be used to improve distribution of the oxidant. Typical oxidant injection rates for commercial applications can range from about 100 to about 30,000 Nm3/hr depending on the containment structure 110 dimensions, and desired gas production rate.

At least one production pipe 22 can be installed at the opposite end of the gasifier to the injection end. The production pipe 22 may be vertical or inclined and shall be designed to handle high temperature product gas from the gasifier at temperatures typically ranging from about 100° C. to about 700° C. The production pipe may be made of carbon or alloy steel with welded joints. The base of the production pipe 22 may be perforated to avoid blockages. If required the product gas may be cooled by injection of water or other fluid directly into the gas or by circulating cooling water through a double walled production pipe. Direct injection of water is simpler and less costly than indirect cooling, however this increases the moisture content of the gas which results in additional condensate production when the gas is cooled in subsequent gas clean-up equipment, such as the ESP. Wastewater produced from gas cooling and clean up may be substituted for fresh water depending on the wastewater properties. Depending on the dimensions of the containment structure 110, multiple production pipes may be required.

Other equipment may also be installed in the containment structure including ignition devices, cooling/quench water pipes and monitoring devices such as thermocouples. In a preferred embodiment, the ignition device is integrated into the tip of the lance 20.

At least a portion of the top of the containment structure 110 should be open during the loading or filling stage and should be completely sealed off from the atmosphere during the gasification stage. A top cover 34 can be in the form of a movable cover plate(s) 34 of hinged, sliding or loose design and made of non-combustible materials such as steel, concrete or refractory which may be used to seal the top of the containment structure 110. In addition to sealing the containment structure 110 from the atmosphere the cover(s) 34 are also used to reduce the heat loss and therefore must have insulating properties. The cover plate(s) 34 are typically exposed to high temperature syngas inside the containment structure and require appropriate materials such as high temperature rated cement or refractory or stainless steel. When in the closed position, a part of the cover 34 extends into a liquid 38, such as water, which is contained within a trough 36. In an embodiment the sealing liquid 38 is water, which over time may become contaminated with light and heavy tars condensing from the syngas and/or partially filled with small pieces of feedstock that may accidently fall into it during loading. Experience with the water seal 38 shows that contamination by liquid or solids is not an operational concern and the trough 36 can be cleaned easily of any debris or contaminated liquids.

Once the containment structure 110 is evenly filled with combustible material 18 the top of the containment structure 110 may be closed off and all openings sealed from the atmosphere. With the reactor lid 34 closed and sealed, the reactor 110 is ready for the heating and purging stage. Inert gas is used to optionally heat and dry the feedstock and also to purge the containment structure 110 of any oxygen. The combustible material may be pre-heated and dried prior to gasification using waste heat from product gas or downstream processes such as power generation or from any other dedicated heat source. This can be achieved by contacting the combustible material with hot syngas, combustion exhaust gases or preheated air or inert gas to evaporate excess moisture. The heating/drying medium can be introduced into the material through the oxidant injection pipe 20, through outlets in the rams 168 or through other outlets which distribute the heating gas into the containment structure and are specifically installed for this purpose. In a preferred embodiment, the heating gas is fed into the containment structure through one or more gas injectors 35 located on or within the floor 14 of the structure. During the heating and purging stage, the inert gas has its pressure increased moderately by blower 182 and is heated by heater 184, which in a preferred embodiment will utilise waste heat from the down stream users 132. The moisture laden heating gas is collected and send to a cooler 170 where water is condensed and a separator 172, wherein the water 174 is separated from the heating gas, which re-enters the closed circuit to be re-used. During the heating and purging stage, the amount of moisture removed from the feedstock can be easily calculated by reading the level of condensate removed in the separator.

Once heating and purging has been completed and commencement of gasification operations is desired, the injection lance 20 can be inserted fully into the bed of feedstock 18 using the hydraulic mechanism or other method. To commence gasification, an ignition sequence may be carried out by first establishing a flow of an inert gas from the injection pipe 20 to the production pipe 22 and then igniting the combustible material 18 near an outlet of the injection pipe 20 using any suitable means which are described further herein. The initial ignition of the combustible material 18 may be achieved by various means including introducing hot coals, injection of gaseous or liquid fuels such as methane, LPG or fuel oil, but without limitation thereto, use of pyrophoric substances such as a silane or a triethyleneborane gas, but without limitation thereto, or electrical resistance heating. Ignition sources may be inserted through the injection or production pipes or via a separate ignition pipe. The combustible material 18 may also be ignited by using a burner with an extended handle prior to closing the final cover plate. Once ignited the process is self-sustaining and does not require additional ignition energy sources. However, if the combustion zone is extinguished then re-ignition may be required using similar methods to the initial ignition.

In a preferred embodiment, the lance tip 24 contains an electric heating element which is used to heat an inert gas which travels from the injection member 20 through oxidant outlets in the tip and into the bed of feedstock 18 and then into the syngas outlet pipe 22. Once the zone around the lance tip 24 has been heated to above the auto-ignition temperature of the feedstock by the inert gas, the inert gas can be slowly replaced with an oxidant, such as pure oxygen, by manipulating the flow control valves. This will then commence combustion and gasification reactions in the vicinity of the lance tip 24.

The injection lance 20 is used to feed or convey the oxidant 21 which may be air, oxygen or a mixture thereof. Air or oxygen may be supplied by any suitable means such as air blowers or air compressors and oxygen production or enrichment by membranes, vacuum/pressure swing adsorption or cryogenic air separation. The oxidant may be preheated to improve gasification efficiency using waste heat from the raw syngas or from downstream sources. Water or steam may also be injected along with the oxidant as gasification reagents or for cooling purposes.

The injection lance 20 is preferably made of carbon or alloy steel. Suitable designs for the injection lance 20 include coiled tubing as used in oil and gas applications, flexible tubing or jointed pipe using flanges, threaded couplings or clamps to provide a means to retract or shorten the injection lance and thus reposition the injection point within the gasifier. Methods for retracting the injection point may include shortening the injection lance by removing jointed sections, intentional destruction of joints by heat or mechanical means, burning through the injection lance using a burner inserted in the injection lance or by reeling in a coiled tubing or flexible tubing. Due to the low operating pressure the size of the injection lance may be too large for coiled tubing, therefore a preferred design may use jointed pipe or flexible tubing. Reuse of the injection lance 20 will lower the operating costs, therefore it is preferred to retract the pipe by mechanical means and remove jointed sections to shorten the pipe. In a preferred embodiment one continuous section of tubing or pipe may be used for the injection lance. A nozzle or lance tip 24 may be fitted to the end of the injection lance 20 to increase the velocity or disperse the oxidant exiting the pipe and promote more efficient mixing and gasification. In a preferred embodiment, the lance tip 24 may include multiple oxidant outlets. In another preferred embodiment, the distance the injection member 20 is retracted each time in the sequence of retractions is set equal to the distance between adjacent oxidant outlets in the lance tip. This ensures that the gasification zones formed from the two or more adjacent positions of the injection member will overlap, which helps to ensure that the gasification process is not extinguished during the movement of the injection member. In another embodiment, the injection member is retracted very slowly, so that the gasification zone generated by the oxidant outlet nozzles has time to adjust its position naturally as the injection member is moved.

An alternative injection lance 20 design involves a fixed or retractable pipe which contains a series of holes or nozzles along its length creating multiple simultaneous injection points. If the nozzles are located along the entire length of the injection lance then the gasification process can proceed evenly along the length of the gasifier and retraction of the injection point is not required. A fixed injection lance does not require joints and may be fully welded. This design also has the benefit of creating an extended high temperature zone along the length of the gasifier resulting in greater destruction of tars. Syngas produced at injection points near the inlet of the gasifier flows towards the production pipe and is reheated as it passes through other injection points located downstream. This design can also be used to create an injection point near the outlet of the gasifier to increase the syngas temperature and promote thermal destruction of tars.

In an embodiment, a specific arrangement of oxidant outlet nozzles is made in the lance tip 24 and along the length of the oxidant injection member 20. In an embodiment the arrangement is made in order to simultaneously increase the conversion of the feedstock 18 into syngas and to minimise the amount of tars in the syngas.

In one embodiment, although not necessarily a preferred embodiment, the injection lance 20 is located inside a perforated liner pipe (not shown) in order to prevent friction on the injection lance during retractions due to the weight of biomass on the pipe and to maintain a flow path to the production pipe. The perforated liner may be made from carbon or alloy steel and may have perforations in various patterns and various hole shapes and sizes. Typically, the perforations are staggered and provide an equivalent open area in the range of 30% to 80%. The perforated liner may extend up to the end of the injection lance or it may extend all the way to the base of the production pipe and may be connected to the base of the production pipe. The perforated liner may include solid sections to seal off the overlying biomass from the injection lance at desired locations and to create a seal at the point where the perforated liner exits the containment structure 110. A dynamic seal between the injection lance 20 and the liner is also required near the inlet to the containment structure 110 to prevent oxygen ingress and syngas leakage through the annulus during retractions.

Direct injection of water into the gas may be accomplished by a quench pipe (not shown) which conveys water to the base of the production pipe and injects water via a spray nozzle either upstream of the production pipe or inside the inlet of the production pipe. The spray nozzle is sized to produce a sufficiently fine spray of water to cause rapid evaporation and cooling of the gas to the desired temperature within a certain distance. In an embodiment, a hydrocarbon or other fluid is used instead of water in the quench pipe.

A typical gasification step will involve one or more injection members 20 being fully inserted into the combustible material, which can be biomass 18. The biomass is ignited using the methods described above to form one or more gasification zones. These gasification zones are then moved backwards through the bed of biomass 18 from the syngas production outlet end to the injection end, by moving or retracting the injection members 20. When each injection member 20 has reached the injection side or fully retracted position and further retraction while gasification continues is no longer feasible, the oxidant injection flow is ceased and the process transitions to the cooling and purging stage.

During the cooling and purging stage, an inert gas 180 at ambient temperature has its pressure moderately increased by the blower 182 and is injected into the bed of feedstock in the containment structure 110′ with the heater 184 not in operation or bypassed. The cool inert gas is distributed into the containment structure. In one embodiment the inert gas is passed into the rams 146 which act like a plenum via a pipe which extends out of the housing (not shown) and then injected via outlets 168 in the ram face 152 into the containment structure. In another embodiment the inert gas is injected via dedicated gas injection members 35 located in or on the floor 14 of the containment structure. During the initial stages of cooling and purging, the syngas left over from the gasification stage is purged from the containment structure through the production pipe 22. In a preferred embodiment this syngas is mixed with syngas currently being produced by another containment structure 110. Once of the syngas from containment structure 110′ has been removed, the cooling and purging step may continue with the gas exiting the reactor to the cooler 170 and then purged to atmosphere via a vent. In an embodiment, the purge gas, which will be almost completely inert gas, is vented directly to atmosphere via vents (not shown) connected to the containment structure.

After cooling and purging with an inert gas is complete, the containment structure can be purged with air using the same equipment. In an embodiment, air 181 is moderately increased in pressure by the blower 181 and injected into the containment structure via any of the means used for the inert gas. During this stage, the heater 184 is either not operated or the air flow bypasses the heater 184. Once the containment structure 110 has been purged with air, the doors 162 of a mechanical solid removal system can be moved from the closed position to the open position, to expose an opening for solids to be discharged from. Hydraulic piston rods 166 that actuate in hydraulic cylinders 155 may then be activated, to push out the bottom most solid layer of material in the bed 18 from the bottom of the containment structure 110 using rams 146. This bottom most layer of solid material then discharges from the openings 156 via chutes 160 and may fall to the ground or more typically, it will be collected in a bin or conveyor placed below discharge point of the containment structure 110.

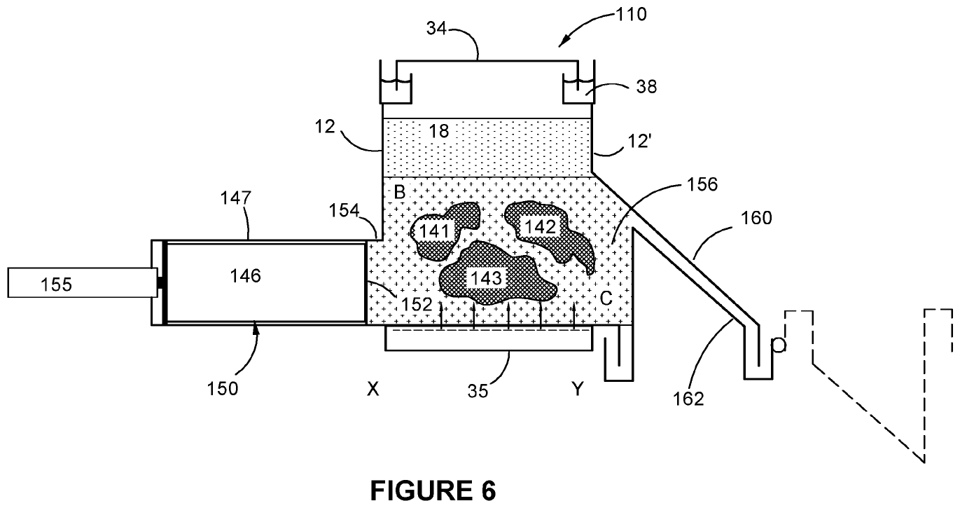

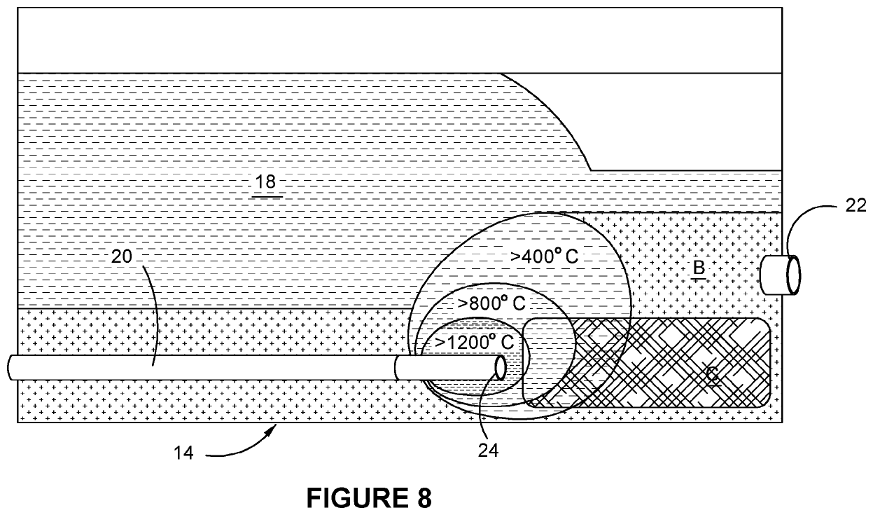

Solid agglomerates of material such as char 141, ash 142 and or slag 143 can be formed during the gasification process in quantities based on the inorganic content of the feedstock 18. The high local temperature during gasification causes this ash to melt and upon cooling form a slag layer 143 at the bottom of the containment structure, as seen in FIG. 6 and FIG. 8. The solid removal system comprises one or more rams 146 associated with the containment structure 110. The containment structure 110 can have a top surface where the lid 34 is located, side walls 10, 10′ and 12, 12′ and a bottom surface 14. The or each ram 146 can be located adjacent to the bottom surface 14 of the containment structure 110. The or each ram 146 can be movable into the containment structure 110 so as to shift, move, push, transfer or discharge solid waste from the bottom surface 14 of the containment structure 110. Each ram 146 is housed outside of the containment structure 110 in a housing structure 147.

The ram can have a top surface 148, a bottom surface 150 and a ram face 152. Since the ram 146 has to move into the containment structure 110 through the combusted material 18 and then is retracted once the solid waste 142 has been ejected, the top surface 148 of the ram 146 is preferably a support surface. As the ram 146 moves forward, the material 18 not discharged from the containment structure 110 will rest on the support surface 148. As the ram 146 is retracted, the thermally affected material including combustible material will move off the support surface 146 and drop under gravity to the bottom 14 of the containment structure 110.

The rams 146 can each be located on a first side X of the containment structure 110. There can be one or more openings 154 in the first side of the containment structure 110 which allow passage of the ram 146 into the containment structure 110.

Optionally, when the ram 146 is not in use, the ram face 146 can itself become part of the seal for the opening 154 in the first side X of the containment structure 110, whereby a ram face 152 aligns flush with the opening 154 and forms a part of the containment structure wall 110 (see FIG. 6). In this embodiment, an appropriate sealing system (not shown) will also need to be installed to ensure the containment structure remains gas tight.

There can be one or more openings 156 on the opposite side Y of the containment structure, the second side Y, through which solid material 141, 142, 143 is discharged. The or each ram 146 can transfer forces to the solid material 141, 142, 143 which is ploughed towards the openings 156 in the second side Y where it is then discharged. In some embodiments, if there are multiple openings 156, the wall provided between each opening can be shaped like a wedge 158. The wedge 158 can extend inwardly of the containment structure 110 and can serve the function of directing solid material to the opening 156, and or breaking up larger pieces of solid material in form of ash 142 or more typically slag 143 that are impaled on the wedge surface 158.

To assist in discharge of the solid material 141, 142, 143, the or each opening 156 in the second side Y of the containment structure 110 can be associated with a passageway or chute 160 which takes the solid material by gravity to a bin or other collection means. The passageway or chute 160 associated with the openings 156 in the second side Y of the containment structure 110 can be covered over the top part of the opening by a cover 160 to prevent or reduce the chance that discharged solid waste 141, 142, 143 will disperse into the atmosphere as it is ejected. This is of particular importance in relation to the char 141 which can consist of fine particles and particulates.

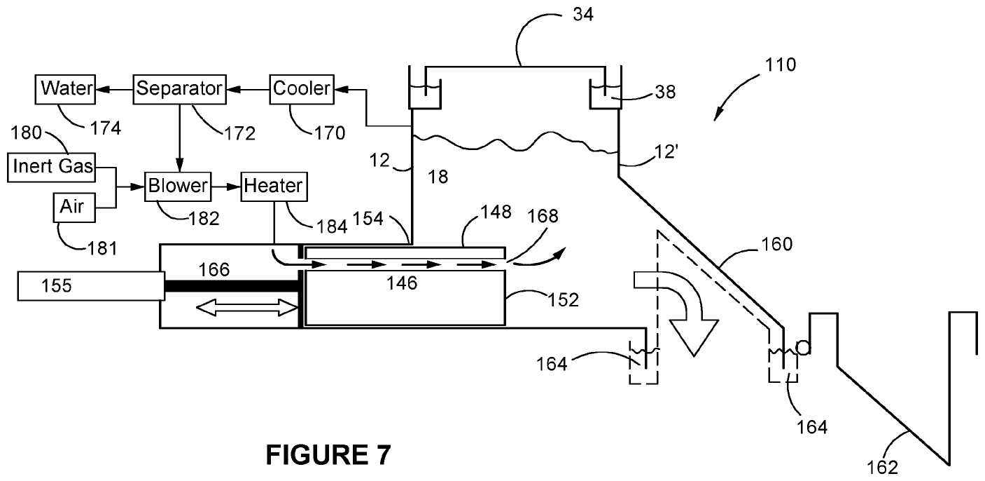

Each opening 156 in the second side Y of the containment structure 110 has a door 162. In an embodiment, there is a hinged door 162 which extends out of the chute 160 when open but which can move upwardly and into the chute 160 when the door 162 is closed for gasification. The door 162 can be complementary in shape to the interior of the chute 160. The door 160 can have a trough shape 164 which upon swinging inside the chute 160 allows for a liquid seal 164 to form around the outside edge of the door 162 and the inside of the containment structure (See FIG. 7).

Preferably, the ram face 152 is a flat area which is able to apply force against the solid waste materials 141, 142, 143 forcing them into the direction of travel of the ram 146 towards opening 156. The or each ram can be mounted on one or more hydraulically operated piston rods 166. The ram face 152 can be pushed by the piston rod 166.

The amount of the thermally affected combustible material that is discharged as solid material upon each stroke of the piston will depend on the area of the ram face 152. The larger the ram face, the more solid waste will be discharge. The ram face 152 can be a flat plate. The ram face can have a shape which assists in discharge of waste. In an embodiment, the ram face can be plough shaped, with two plates meeting at a point in the middle. The ram face can have surface patterns or undulations that assist in collecting up fine particles or capturing larger particles by friction and carrying with the ram face as it traverses the containment structure in operation.

There can be one ram 146 moving from a first side X of the containment structure 110 to the second side Y of the containment structure 110. Where the containment structure is elongate with a pair of longitudinal sides 12, 12′ and two shorter sides 10, 10′, the first side X and second side Y can be the pair of longitudinal sides 12, 12′. It may be advantageous to arrange the rams to be movable from one of the longitudinal sides to the other, because the pathway over which the ram has to travel is relatively shorter.

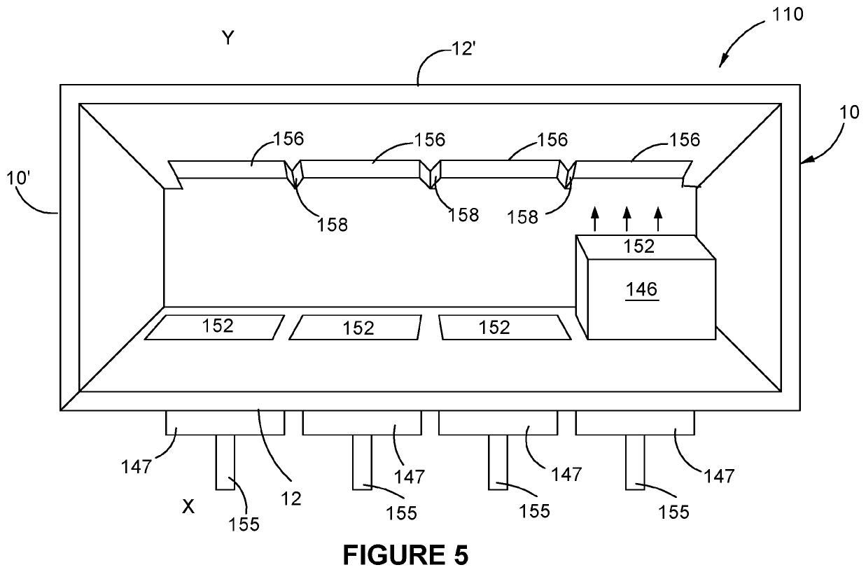

There can be a plurality of rams 146 each ram existing alongside the other. In e.g. FIGS. 2 and 5 there are shown four rams 146. There is some spacing required between each of the rams 146 to allow for their mechanical movement, and to allow for any operation deviation. Preferably, the rams 146 are as close to one another as possible when arranged side by side to avoid any area on the containment structure floor 14 that is not coverable by the ram's 146 passage from one side to the other.

Referring to FIGS. 6 and 7, a series of cross sectional schematics of the containment structure in preferred embodiments for the hydraulic cylinders 155, hydraulic piston rods 166 and rams 146, collectively called hydraulic rams. FIG. 6 shows a schematic of the solid material door 162. The door can be shaped to align with the chute 160 and also to form a liquid seal 164 between the openings for the door 162 in the containment structure 110. The door 162 can be opened by rotation around a pivot point as shown in the Figures. In the fully open position, the door 162 may rest in an upside down position on the outside of the chute 160, thereby creating a large opening for solids to be discharged from the containment structure 110. Due to the shape of the door 162 and the nature of the liquid seal 164, the liquid in the seal can be removed and replaced before and after opening of the door.

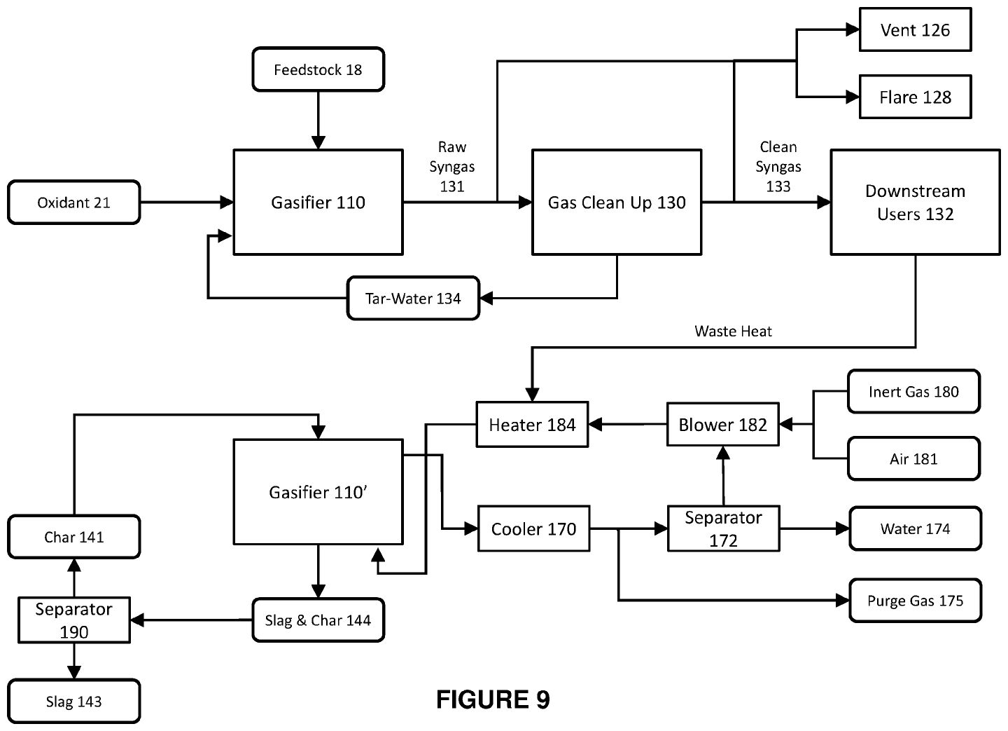

Referring to FIG. 7 and FIG. 9, there are shown the process steps required in the closed-loop drying system. An inert gas, such as nitrogen 180, or air 181 is increased in pressure by a blower 182 and passed through a heater 184 to increase its temperature from around ambient temperature to up to 150 degrees Centigrade. In an embodiment the heater 184 will be a heat exchanger which heats up the inert gas 180 or air 181 using waste heat from downstream users 132 located somewhere else in the process, such as extraction of waste heat from a gas engine or syngas boiler. The humid gas is collected towards the top of the containment structure and passed through cooler 170 to condense moisture which is split at the separator 172 into water 174 which is collected and gas which is re-used in the blower 182.

In embodiments, as seen in FIG. 7, the ram 146 can inject gas into the containment structure 110 when it is stationary, moving or in any position. The gas can be air, nitrogen, carbon dioxide or syngas. The gas can be used for heating, cooling or purging. The ram 146 can be used to inject the gas at different positions depending on the ram position in order to distribute the gas throughout the containment structure 110. In an embodiment, the ram 146 comprises one or more openings 168 to inject the heating gas, the purging gas and or the cooling gas into the containment structure 110. There can be one or more openings 168. The openings can be provided in the ram face 152 as shown in FIG. 7. The gas may be distributed to the rams 146 in many different ways. In an embodiment, gas is injected into the space formed by the housing 147 and the hydraulic piston rods 166 and transferred via conduits in the rams 146 to the openings 168. In another embodiment (not shown), gas is passed through a fixed pipe in the housing 147, and into a plenum formed inside the rams 146 as they move. The length of the fixed pipe is chosen such that it can discharge the gas into the rams 146 when the hydraulic piston rod 166 is in both the retracted and extended positions.

The inert gas or air outlet holes 168 could be designed such that the gas is evenly distributed across them, and the outlet holes 168 themselves may be orientated so they point downwards from the ram face 152. This will protect them from any solid debris or other material that may have otherwise entered and interfaced with the rams if they had been orientated in another manner, e.g. via outlet holes directly in the face of the rams 152. The hot inert gas or air heats up the feedstock 18 releasing moisture which is carried out of the reactor via an appropriately sized duct positioned above the top level of the feedstock. This humid gas is sent to a cooler 170 where it is condensed and then to a separator 172 where it is separated as a liquid (water) 174 from the gas. The gas is then returned to the blower and the cycle is repeated. Obviously, in order to form a closed-loop, all of the components in this heating or cooling system need to be gas tight and there are seals everywhere with the outside atmosphere.

Referring now to FIG. 8, there is shown a schematic cross-section of the containment structure during the gasification stage of operations. Oxidant is being injected through the injection member 20 and exits from the lance tip 24 into the bed of solid material to form a high temperature gasification zone around the injection member. Right in the vicinity of the lance tip 24, the reaction of the oxidant with the char 141 formed within a thermally affected layer from a previous gasification run then forms a high temperature zone greater than 1200 degrees Centigrade. This zone is sufficiently high to melt the inorganic material in the char 141 to form slag agglomerates 143 in zone C. If the peak temperature is lower then ash 142 may be formed in zone C. Outside of the peak temperature zone, lower temperature zones will exist as shown. In a zone of temperature above 800 degrees Centigrade, carbon dioxide and steam will react with char 141 to form the primary products of syngas, namely carbon monoxide and hydrogen via well known gasification reactions. Extending further into the biomass 18, low temperature zones will exist. At temperatures above about 400 degrees Centigrade, most biomass and waste materials pyrolyse releasing volatile matter molecules which form tars, hydrocarbon molecules with anywhere from 1 to 100 carbon atoms each and carbon monoxide, carbon dioxide, hydrogen and steam and forming char 141 in zone B. At lower temperatures still, the biomass 18 will be dried and may shrink and change shape due to the presence of moderate temperatures. A sequence of thermally affected layers is therefore created by the zones of elevated temperature emanating from around the vicinity of the lance tip 24. There can be no precise description or definition or shape for each layer, but in general, observations show that the layers are orientated horizontally, with the largest changes in the vertical direction. More highly affected layers are generally located towards the bottom of the containment structure and less thermally affected layers are at the top of the containment structure. The gases produced from all temperature zones, collectively known as syngas, migrates through the thermally affected material to the syngas production pipe 22. These thermally affected zones also extend laterally, with the less affected thermal layers being close to the walls of the containment structure.

As the oxygen injection member 20 is retracted, the high temperature zones are moved progressively through the biomass 18 generating the thermally affected layers, and in particular generating char 141 and generating slag 143. As can be seen in the schematic, the slag 143 will form in zone C in the vicinity of the oxidant injection member and be one of the bottom-most thermally affected layers. While char 141 will form in zone B. Above zone B, the biomass 18 will experience temperatures below about 400 degrees Centigrade and therefore will be moderately affected by the thermal treatment—for example it may undergo torrefaction, mild pyrolysis and moisture evaporation. It is obvious that the nature of the changes due to thermal treatment in the various zones shown on the schematic of FIG. 8, will depend heavily on the composition of the feedstock. If the feedstock predominately consists of plastics, then thermal decomposition will be more severe at lower temperatures than if the feedstock was predominately biomass.

During the unloading stage, the slag 143 and char 141 in the bottom-most layer will be discharged from the containment structure 110 by the rams 146. Referring to FIG. 9, the slag and char 144 may be collected as a mixture in a bin or conveyor and then separated in a separator 190 to form slag 141 and char 143. The char 143 can be recycled to the gasifier 110′ during its loading stage. The separator 190 may be a screen or a series of screens or any other device that can separate small char particles from larger slag pieces; or light char particles from dense slag pieces. In an embodiment the char 143 may be stored and used for other purposes. For example, it may be returned to soil in order to sequester carbon or for use as a substrate for fertilisers, or it may be combined with asphalt to be recycled for re-use in roadmaking and sequestering carbon. It is obvious that there are many potential uses for the char 143 in addition to returning it to the gasifier 110′ to make more syngas.

Continuing to refer to FIG. 9, the product gas may initially be directed to a vent 126 during ignition due to the potential for oxygen in the gas and possibly explosive gas mixtures. Once positive ignition is confirmed and oxygen content in the product gas is below the safe limit the gas may be sent to a flare 128 and the oxidant injection rate may be increased to the normal design rate for gasification. Once the syngas quality is acceptable the raw syngas 131 may be sent to downstream gas cleanup 130 to produce clean syngas 133 for end users 132. Any tar-water 134 residue from the gas cleanup process 130 can be recycled to the gasifier 110 during gasification operations. A suitable injection rate is dependent on the size of the containment structure 110, the required gas production rate and the kinetic limitations of the gasification process including heat and mass transfer limitations and the reactivity of the biomass. In an embodiment the tar-water 134 and char 143 may be mixed with a portion of the feedstock 18 in order to form a slurry mix that is loaded into the gasifier 110′ like a solid. This embodiment has the advantage that dedicated injection lines, control valves and flow measurement devices are not needed to control the tar-water 134 fluid recycle.

Typically, the highest temperatures occur near the injection point this can be seen in the schematic of FIG. 8. This is due to combustion of biomass 18 and syngas surrounding the injection point in zone A. Heat generated from exothermic reactions causes drying and pyrolysis of the combustible material 18 surrounding and downstream of the combustion zone which turns to char and the char is converted to syngas by gas-solid reactions including reactions with H2, CO2 and H2O. Gas-phase reactions also occur including water gas shift and methanation reactions. The syngas naturally cools as it flows towards the production pipe 22, however further cooling of the gas may be required due to material limitations in the production piping and downstream equipment. The hot product gas is typically comprised of a mixture of N2, H2, CO, CO2, CH4, H2O, tars and other minor constituents.

During normal gasification operations the raw syngas 131 is directed to the gas clean-up equipment 130 and downstream users 132. The gasifier 110 operating pressure and product gas pressure is near to atmospheric to avoid gas leakage and air ingress into the containment structure 110. If the fuel 18 surrounding the injection point 24 is consumed the gasification efficiency drops and product gas quality is degraded. In order to avoid this and maintain high syngas quality the injection point 24 may be periodically or continuously retracted to consume fresh combustible material 18. The syngas product gas flow rate and composition may be controlled by varying the oxidant injection rate, composition and injection location. In an embodiment at least 30% and not more than 80% of the carbon in the feedstock is converted to syngas in each gasification cycle. In a preferred embodiment more than 50% of the carbon in the feedstock is converted to syngas in each gasification cycle. In the event that the gasifier 110 needs to be shut down, the oxidant injection may be ceased and excess product gas flared. The methods of the present disclosure may include ceasing oxidant injection to extinguish a gasification reaction. If required, water may be injected to quench and cool the gasifier after ceasing oxidant injection.

The hot raw syngas may be cooled and cleaned according to typical industry practice for biomass-derived syngas. Due to the long residence time and low velocities in the gasifier the production of heavy tar and particulates can be significantly lower than other biomass gasifiers, especially fixed bed and fluidised bed gasifiers which operate at low to moderate temperatures. This reduces the cost and complexity of gas clean-up processes.

Once injection member 20 has been retracted into the fully retracted position and the combustible material 18 is partially consumed the containment structure 110 is cooled and purged with an inert gas. In industrial facilities, the syngas produced during purging is initially mixed with raw syngas from an operating gasifier 110′. Once the syngas is heavily diluted and predominately now an inert gas it can be routed to vent or flare. Purging with air can oxidise any noxious combustible gases and liquids, however care must be taken to ensure that explosive mixtures are not formed. Once the containment structure 110 atmosphere is safe the top of the containment structure 110 is opened to allow re-instatement of equipment and refilling with the combustible material 18 in the form of a biomass material.

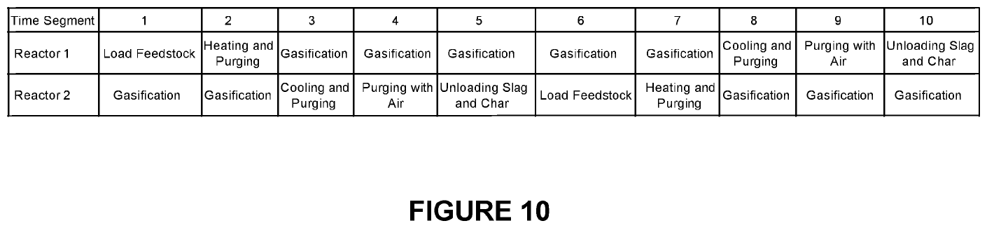

FIG. 10, shows an operating schematic for two gasifiers or containment structures, called Reactor 1 and Reactor 2 over a time period represented by 10 discrete time segments. Focusing first on Reactor 1, in time segment 1 the reactor is loaded with feedstock. In time segment 2 the heating and purging stage is undertaken to dry the feedstock, removing moisture and purging the containment structure to remove any oxygen present. Once the purging procedure is complete, ignition can commence leading to the gasification operations stage which extends from time segment 3 through to time segment 7 (5 steps). Once gasification has stopped, the cooling and purging stage will be performed in time segment 8 and purging with air will be completed in time segment 9. Finally, the unloading stage will involve solid removal doors being opened and the rams used to discharge solid material predominately in the form of slag and char from the reactor in time segment 10. Then the operational stages will be repeated from time segment 11 onwards and thereafter. In the case of Reactor 1, syngas production occurs from time segment 3 to time segment 7. Now focusing on the operational stages of Reactor 2, it can be seen that the exact same operational stages are performed in the same sequence, however, they are offset in time by 5 time segments. This is arranged, so that as Reactor 1 comes to the end of its gasification stage, Reactor 2 is commencing its gasification stage, thereby ensuring that syngas production remains steady and continuous for the gas clean up equipment and the downstream users.

It is understood that the above example is just a simple example of the operational stages for two reactors and that the same principles may be applied to two or more gasifiers operating as a system. The actual time required for each operational stage will vary based on a large number of factors. Thus, the number of time segments required for each stage can vary significantly. However, what is critical when considering two reactors, is that the gasification operational time must at least be equal to or greater than the cumulative time required for loading, heating and purging, cooling and purging, purging with air and unloading.

It is to be understood that, if any prior art publication is referred to herein, such reference does not constitute an admission that the publication forms a part of the common general knowledge in the art, in Australia or any other country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

Any promises made in the present description should be understood to relate to some embodiments of the invention and are not intended to be promises made about the invention as a whole. Where there are promises that are deemed to apply to all embodiments of the invention, the applicant/patentee reserves the right to later delete them from the description and does not rely on these promises for the acceptance or subsequent grant of a patent in any country.

1. A method of producing a gas from a combustible material,
comprising:
(a) loading the combustible material into a containment structure having a first side and a second side arranged along either side of an elongate axis;
(b) substantially sealing the containment structure;
(c) feeding an oxidant via an oxidant injection point into the sealed containment structure and igniting the combustible material;
(d) moving the oxidant injection point from one end to the other end of the containment structure;
(e) controlling a flow rate of oxidant and a rate of movement of the oxidant injection point such that the combustible material is partly converted, thereby leaving behind thermally affected layers of combustible material in the sealed containment structure after the injection point has passed through the material;
(f) cooling and purging the sealed containment structure;
(g) unsealing the sealed containment structure to load fresh combustible material on top of the top-most thermally affected layer left behind after completing (c) to (e), wherein during (e) at least some of the combustible material is converted into at least one of molten slag and char that accumulates as the bottom-most thermally affected layer and subsequently cools and solidifies;
discharging at least one of solid slag and of char in the bottom-most thermally affected layer from under material that remains in the containment structure to remove at least one of the solid slag and the char from the containment structure; and
(h) repeating (a) to (g).

2. The method to of claim 1, wherein the discharging is undertaken by one or more rams operable to discharge at least one of the solid slag and the char by movement from the first side of the containment structure towards an openable/closable opening in the second side of the containment structure.

3. The method of claim 1, wherein after (b) and before (c), the method comprises heating the combustible material with a heating gas to pre-dry the combustible material.

4. The method of claim 2, wherein at least one of the one or more rams comprises one or more openings to inject at least one of the heating gas if present, the purging gas, and of the cooling gas into the containment structure.

5. The method of claim 4, wherein the ram comprises a ram face, a top surface and a bottom surface, and the one or more openings are located in the ram face.

6. The method of claim 1, wherein the combustible material is partially converted to char without forming slag.

7. The method of claim 1, wherein the combustible material is converted to slag and char.

8. The method of claim 7, further comprising:
collecting at least one of solid slag and char removed from the containment structure; and separating solid slag from any char if both are present; and
adding any separated char with the reloaded fresh combustible material in (g).

9. The method of claim 1, wherein there is more than one ram disposed along the elongate axis of the containment structure.

10. The method of claim 1, wherein there is more than one openable/closable opening in the second side of the containment structure, wherein each opening is closable by a trough door comprising a water seal.

11. The method of claim 1, wherein the combustible material is municipal waste.

12. The method of claim 1, wherein at least one of the heating gas, the cooling gas, the purging gas is nitrogen.

13. The method of claim 1, wherein moving the oxidant injection point from one end to the other end of the structure comprises retracting an injection member along an elongate axis of the containment structure.

14. A containment structure for use as a gasifier, comprising:
a bottom, a first side and a second side arranged along either side of an elongate axis, the containment structure configured to be: loaded with a combustible material; sealable once loaded with combustible material; heated once sealed with a heating gas to pre-dry the combustible material; and activated into a producing stage according to (e) of claim 1 wherein during (e) at least some of the combustible material is converted into at least one of molten slag and char that accumulates as the bottom-most thermally affected layer and subsequently cools and solidifies;
one or more rams movable from the first side of the containment structure to the second side of the containment structure; and
one or more openable/closable openings in the second side of the containment structure for discharging at least one of the solid slag and the char out from under material that remains in the containment structure.

15. Char recovered from the containment structure of claim 14.

16. The method of claim 1, further comprising:
providing a containment structure for use as a gasifier, the containment structure having a bottom, a first side and a second side arranged along either side of an elongate axis, the containment structure configured to be: loaded with a combustible material; sealable once loaded with combustible material; and heated once sealed with a heating gas to pre-dry the combustible material; activated into a producing stage according to (e), wherein during (e), at least some of the combustible material is converted into at least one of molten slag and char that accumulates as the bottom-most thermally affected layer and subsequently cools and solidifies;
providing one or more rams movable from the first side of the containment structure to the second side of the containment structure; and
providing one or more openable/closable openings in the second side of the containment structure for discharging solid slag and or char out from under material that remains in the containment structure.

17. The method of claim 16, further comprising recovering char from the containment structure.
